(19) United States
(12) Patent Application Publication
(10) Pub. No.: US 2013/0107065 A1
(43) Pub. Date: May 2, 2013

(54) INERTIAL SENSOR AIDED STATIONARY OBJECT DETECTION IN VIDEOS

(71) Applicants: Subramaniam VENKATRAMAN, Fremont, CA (US); Carlos M. Puig, Santa Clara, CA (US)

(72) Inventors: Subramaniam VENKATRAMAN, Fremont, CA (US); Carlos M. Puig, Santa Clara, CA (US)

(73) Assignee: QUALCOMM Incorporated, San Diego, CA (US)

(21) Appl. No.: 13/455,837

(22) Filed: Apr. 25, 2012

Related U.S. Application Data
(60) Provisional application No. 61/552,378, filed on Oct. 27, 2011.

(51) Int. Cl. H04N 5/232

(52) U.S. Cl. CPC H04N 5/23248
USPC 348/208.4

(57) ABSTRACT

Techniques described herein may provide a method for improved stationary object detection utilizing inertial sensor information. Gyroscopes and accelerometers are examples of such inertial sensors. The movement of the camera causes shifts in the image captured. Image processing techniques may be used to track the shift in the image on a frame-by-frame basis. The movement of the camera may be tracked using inertial sensors. By calculating the degree of similarity between the image shift as predicted by image processing techniques with motion of the device estimated using an inertial sensor, the device can estimate the portions of the image that are stationary and those that are moving.

### CROSS-REFERENCES TO RELATED APPLICATIONS

This application claims priority to U.S. Provisional Application No. 61/552,378 entitled “INERTIAL SENSOR AIDED STATIONARY OBJECT DETECTION IN VIDEOS,” filed Oct. 27, 2011 and is hereby incorporated by reference.

### BACKGROUND OF THE INVENTION

A common problem in video analysis is to differentiate a stationary object from moving objects. Competent video analysis relies on the ability to differentiate stationary objects (e.g., background object) from moving objects (usually in the foreground). Numerous techniques exist to perform background subtraction based on image processing algorithms. However, many of these techniques suffer from an inherent limitation of relying on the size of the moving object being small in comparison to the complete image. Traditional approaches also suffer from an inherent limitation that they cannot distinguish between camera motion and subject motion.

Finding a stationary object from a non-stationary camera is applicable when considering mobile device videos that are subject to continuous unintentional tremor and occasional panning. It is also equally applicable when the camera is mounted on a mobile platform like a robot, a plane, an unmanned aerial vehicle (UAV), etc. In most cases, the section of the image that is stationary is the background and techniques described herein offer a powerful method to achieve background identification and subtraction. Ability to discover stationary objects using the techniques described herein have numerous applications like surveillance, intruder detection and image stabilization.

Embodiments of the invention address these and other problems.

### SUMMARY

Techniques for identifying stationary objects are provided, herein. Integrated inertial MEMS sensors have recently made their way onto low-cost consumer cameras and cellular phone cameras and provide an effective way to address this problem. Gyroscopes, accelerometers and magnetometers are examples of such inertial sensors that may be used in embodiments of the invention. Gyroscopes measure the angular velocity of the camera along three axes and accelerometers measure both the acceleration due to gravity and the dynamic acceleration of the camera along three axes. These sensors provide a good measure of the movement of the camera when held by a user. This includes movements caused by panning as well as unintentional tremor.

The movement of the camera causes shifts in the image captured. Known image processing techniques may be used to track the shift in the image on a frame-by-frame basis. The movement of the camera is also tracked using inertial sensors like gyroscopes. The expected image shift due to the camera motion (as measured by the inertial sensors), is calculated by appropriately scaling the camera movement taking into account the camera's focal length, pixel pitch, etc.

Some regions of the image may show strong similarity between the inertial sensor estimated image shift and the image shift calculated by known image processing techniques. The portions of the image may be defined as sub-frames of the image or individual fine grained features identified and described by using known techniques such as scale invariant feature transform (SIFT). By calculating the degree of similarity between the image shift as predicted by known image processing techniques with that estimated using an inertial sensor, the device can estimate the regions of the image that are stationary and those that are moving, discounting the motion or shift introduced by the motion of the camera.

An example of a method for identifying a stationary portion of an image may include obtaining a sequence of images using a camera, identifying multiple portions of an image from the sequence of images, detecting a shift associated with each of the multiple portions of the image, detecting a motion using a sensor mechanically coupled to the camera, deriving a projected shift for the image based on the detected motion of the camera using the sensor, comparing the projected shift associated with the motion using the sensor with the shift associated with each portion of the image, and identifying a portion of the image that is most similar to the projected shift associated with the motion detected using the sensor, as the stationary portion of the image. Identifying multiple portions of the image may include identifying multiple features from the image. The sequence of images may belong to a video stream.

In some embodiments, detecting the shift associated with each of the multiple portions of the image may include associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. In other implementations, detecting the shift associated with each of the multiple portions of the sequence of images may entail analyzing the similarly situated corresponding portions throughout the sequence of images.

In some implementations, a projected shift for the image is derived using a scaled value of the motion detected from the sensor. The sensors used may be inertial sensors that are one or more from a group comprising of gyroscope, an accelerometer and a magnetometer. The shift in the image may be from movement of the camera obtaining the image or by an object in the field of view of the camera.

The shift of different portions in the image may be correlated with the motion detected using the sensor. In some situations, the camera may be non-stationary and attached to device. In some aspects, the similarity in the motion of the different portions of the image and the motion as calculated by the sensor is calculated as a correlation between the input from the camera and the input from the sensor. Identifying stationary portions of the image may be used for surveillance, moving object detection, intruder detection in videos, and video and image stabilization.

An example device implementing the method may include a processor, a camera for obtaining images, a sensor for detecting motion associated with the device, and a non-transitory computer-readable storage medium coupled to the processor. The non-transitory computer-readable storage medium comprises code executable by the processor for implementing a method that includes obtaining a sequence of images using the camera, identifying multiple portions of an image from the sequence of images, detecting a shift associated with each of the multiple portions of the image, detecting a motion using the sensor mechanically coupled to the camera, deriving a projected shift for the image based on the detected motion of the camera using the sensor, comparing the projected shift associated with the motion using the sensor with the shift associated with each portion of the image, and identifying a portion of the image that is most similar to the projected shift associated with the motion detected using the sensor, as a stationary portion of the image. Identifying multiple portions of the image may include identifying multiple features from the image. The sequence of images may belong to a video stream.

Implementations of such a device may include detecting the shift associated with each of the multiple portions of the image that includes associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. Other implementations of such a device may include detecting the shift associated with each of the multiple portions of the sequence of images which comprises analyzing the similarly situated corresponding portions throughout the sequence of images.

In some implementations, the device derives a projected shift for the image using a scaled value of the motion detected from the sensor. The sensors coupled to the device may be inertial sensors that are one or more from a group comprising of gyroscope, an accelerometer and a magnetometer. The shift in the image may be from movement of the camera obtaining the image or by an object in the field of view of the camera.

In some implementations, the device may correlate the shift of different portions in the image with the motion detected using the sensor. In some situations, the camera may be non-stationary and attached to device. In some aspects, the similarity in the motion of the different portions of the image and the motion as calculated by the sensor is calculated as a correlation between the input from the camera and the input from the sensor. Identifying stationary portions of the image may be used for surveillance, moving object detection, intruder detection in videos and video, and image stabilization.

An example non-transitory computer-readable storage medium coupled to a processor, wherein the non-transitory computer-readable storage medium comprises a computer program executable by the processor for implementing a method, includes obtaining a sequence of images using a camera; identifying multiple portions of an image from the sequence of images; detecting a shift associated with each of the multiple portions of the image; detecting a motion using a sensor mechanically coupled to the camera; deriving a projected shift for the image based on the detected motion of the camera using the sensor; comparing the projected shift associated with the motion using the sensor with the shift associated with each portion of the image; and identifying a portion of the image that may be most similar to the projected shift associated with the motion detected using the sensor, as a stationary portion of the image.

Implementations of such a non-transitory computer-readable storage medium may include detecting the shift associated with each of the multiple portions of the image that includes associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. Other implementations of such a device may include detecting the shift associated with each of the multiple portions of the sequence of images which comprises analyzing the similarly situated corresponding portions throughout the sequence of images.

Implementations of such a non-transitory computer-readable storage medium may include one or more of the following features. In some implementations, the non-transitory computer-readable storage medium derives a projected shift for the image using a scaled value of the motion detected from the sensor. The sensors coupled to the device may be inertial sensors that are one or more from a group comprising of gyroscope, an accelerometer and a magnetometer. The shift in the image may be from movement of the camera obtaining the image or by an object in the field of view of the camera.

In some implementations, the non-transitory computer-readable storage medium may correlate the shift of different portions in the image with the motion detected using the sensor. In some situations, the camera may be non-stationary and attached to device. In some aspects, the similarity in the motion of the different portions of the image and the motion as calculated by the sensor is calculated as a correlation between the input from the camera and the input from the sensor. Identifying stationary portions of the image may be used for surveillance, moving object detection, intruder detection in videos, and video and image stabilization.

An example apparatus performing a method for identifying a stationary portion of an image may include means for obtaining a sequence of images using a camera, means for identifying multiple portions of an image from the sequence of images, means for detecting a shift associated with each of the multiple portions of the image, means for detecting a motion using a sensor mechanically coupled to the camera, means for deriving a projected shift for the image based on the detected motion of the camera using the sensor, means for comparing the projected shift associated with the motion using the sensor with the shift associated with each portion of the image, and means for identifying a portion of the image that is most similar to the projected shift associated with the motion detected using the sensor, as the stationary portion of the image. Identifying multiple portions of the image may include identifying multiple features from the image. The sequence of images may belong to a video stream.

In the above described example apparatus, detecting the shift associated with each of the multiple portions of the image may include means for associating, from the image, one or more portions of the image with a same relative location in the one or more other images from the sequence of images to generate a sequence of portions from the images, and means for determining the shift associated with the one or more portions of the image using deviations in a plurality of pixels in the sequence of portions from the images. In another implementation of the apparatus, detecting the shift associated with each of the multiple portions of the sequence of images comprises a means for analyzing the similarly situated corresponding portions throughout the sequence of images.

In some implementations of the apparatus, a projected shift for the image is derived using a scaled value of the motion detected from the sensor. The sensors used may be inertial sensors that are one or more from a group comprising of gyroscope, an accelerometer and a magnetometer. The shift in the image may be from movement of the camera obtaining the image or by an object in the field of view of the camera.

The shift of different portions in the image may be correlated with the motion detected using the sensor. In some situations, the camera may be non-stationary and attached to a device. In some aspects, the similarity in the motion of the different portions of the image and the motion as calculated by the sensor is calculated using means for correlating between the input from the camera and the input from the sensor. Identifying stationary portions of the image may be used for surveillance, moving object detection, intruder detection in videos, and video and image stabilization.

The foregoing has outlined rather broadly the features and technical advantages of examples according to the disclosure in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 is an exemplary figure illustrating a setting that would benefit from the embodiments of the invention.

FIG. 2 is an exemplary mobile device equipped with inertial sensors.

FIG. 3 is a graph comparing the image shift as calculated using a gyroscope output and image processing techniques.

FIG. 4 is a logical block diagram illustrating a non-limiting embodiment for detecting stationary objects in the video.

FIG. 5 is a non-limiting exemplary graphical representation of the motion associated with the device and the motion detected from the different portions of the image.

FIGS. 6A and 6B are flow diagrams, illustrating an embodiment of the invention for identifying a stationary portion of the image.

FIG. 7 illustrates an exemplary computer system incorporating parts of the device employed in practicing embodiments of the invention.

### DETAILED DESCRIPTION

A common problem in video analysis is to differentiate a stationary object from moving objects (usually in the foreground). Competent video analysis relies on the ability to differentiate stationary objects (e.g., background object) from moving objects. Numerous techniques exist to perform background subtraction based on image processing algorithms. However, many of these techniques suffer from an inherent limitation of relying on the size of the moving object being small in comparison to the complete image. This may provide erroneous results where the moving object is much larger that the stationary object.

Accordingly, a technique for stationary object detection in a video provided herein utilizes inertial sensor information for improved stationary object detection. Gyroscopes, accelerometers and magnetometers are examples of such inertial sensors. Inertial sensors provide a good measure for the movement of the camera. This includes movements caused by panning as well as unintentional tremor. A video may be characterized as a sequence of images. Processing of an image, as discussed herein, may refer to processing of an image from the sequence of images of a video stream in reference to other images from the sequence of images. In some instances, the term “images” may be used interchangeably with the term “video” without departing from the scope of the invention.

The movement of the camera causes shifts in the video captured. Known image processing techniques may be used to track the shift in the video on a frame-by-frame basis. The movement of the camera is also tracked using inertial sensors like gyroscopes. The expected image shift due to the camera motion (as measured by the inertial sensors) is calculated by appropriately scaling the camera movement, taking into account the camera's focal length, pixel pitch, etc.

By calculating the degree of similarity between the image shift as predicted by known image processing techniques and that estimated using an inertial sensor, the device can estimate the regions of an image from a sequence of images that are stationary and those that are moving. Some portions of the image from the sequence of images may show strong similarity between the inertial sensor estimated image shift and the image shift calculated by known image processing techniques. The regions or portions of the image may be defined as components, objects of the image or individual fine grained features identified by using known techniques such as scale invariant feature transform (SIFT). SIFT is an algorithm in computer vision to detect and describe local features in images. For any object in an image, interesting points on the object can be extracted to provide a “feature description” of the object. This description, extracted from a training image, can then be used to identify the object when attempting to locate the object in an image containing many other objects.

The techniques described herein are also applicable when considering handheld digital cameras which are subject to continuous hand tremor and occasional panning. In most cases, the section of the image that is stationary is the background and this technique offers a method for background identification and subtraction with applications in surveillance, intruder detection and image stabilization.

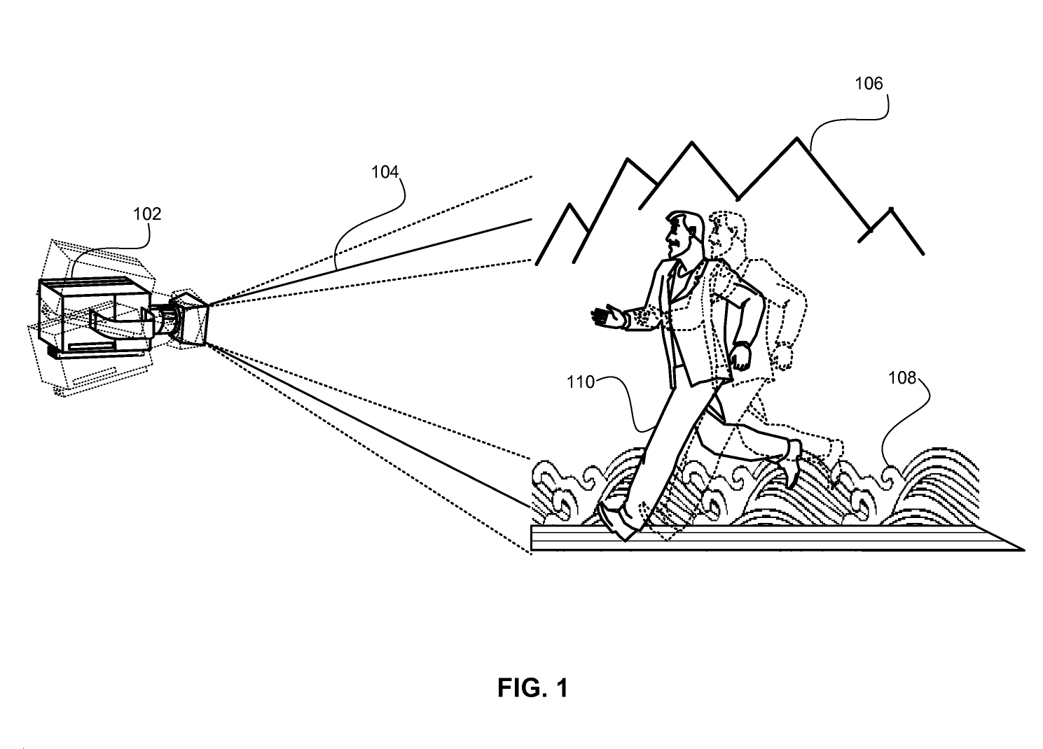

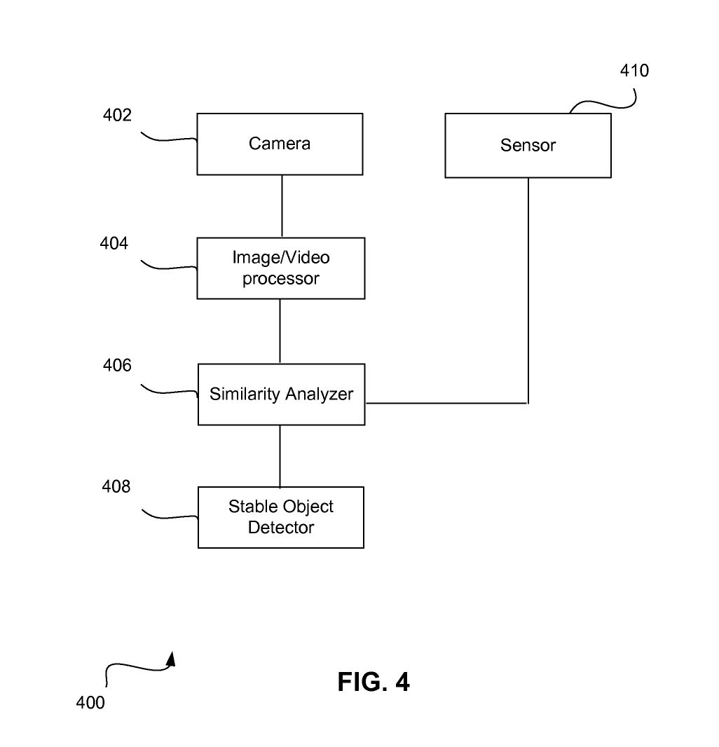

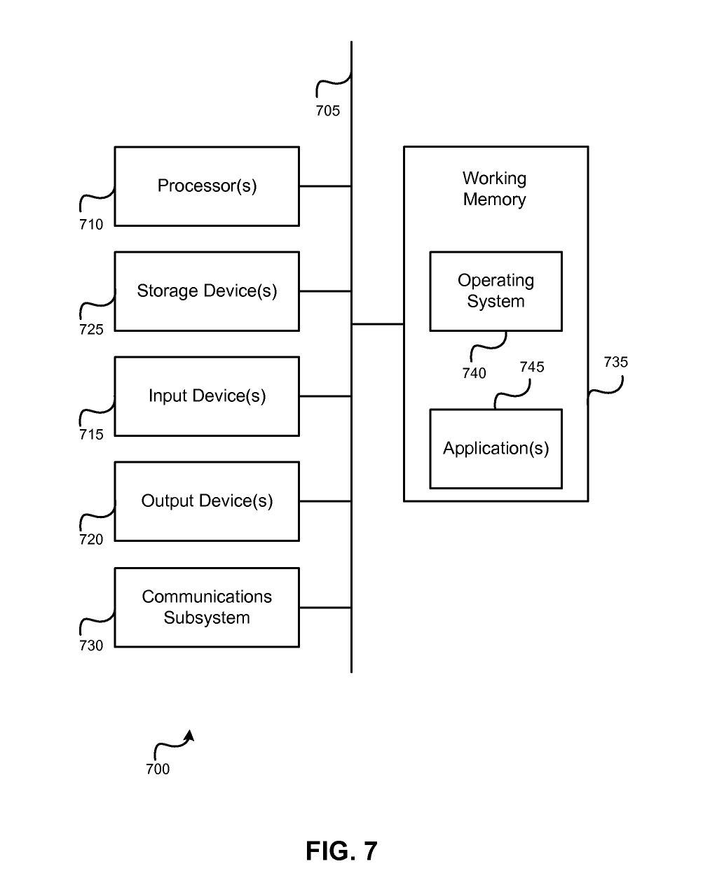

FIG. 1 is an exemplary setting illustrating the inadequacy of traditional techniques for detecting a stationary object in an image or video in situations where the capturing device is unstable and contributes to an image shift. Referring to FIG. 1, a non-stationary device 102 comprising a camera in its field of view has a person 110 and scenery including mountains 106 and ocean waves 108. As described in more detail in FIG. 4 and FIG. 7, the non-stationary device may have a camera and other sensors mechanically coupled to the device. In one aspect, the non-stationary device 102 may be a mobile device. In another aspect, the device 102 is non-stationary because it is mechanically coupled to another moving object. For example, the device 102 may be coupled to a moving vehicle, person, or robot. Computer system 700, further discussed in reference to FIG. 7 below, can represent some of the components of the device 102.

Referring again to FIG. 1, the waves in the ocean 108 may constitute a large portion of the image in the field of view 104 of the camera coupled to the non-stationary device 102. Also, the person 110 may be moving as well. In addition to the moving waves 108 in the background and the moving person 110 in the foreground, the device 102 may be non-stationary. In a common scenario, the hand tremor from a person 110 handling the device contributes to the motion of the device 102 and consequently the camera. Therefore, the obtained images or video have motion from the moving waves 108, the moving person 110 and the hand tremor. Although, the mountain ranges 106 are stationary, the device may not recognize the mountain ranges 106 as stationary due to the motion contributed to the image from the hand tremor. This inability to distinguish between hand tremor and motion by the objects in the image results in difficulty differentiating between a moving object and a stationary object. Also, algorithms in related art that associate larger objects as stationary objects may not appropriately find stationary objects in the scene described in FIG. 1, since the waves in the ocean 108 are continuously moving.

Related image processing techniques are valuable in detecting motion associated with an image or portions of the image. However, these traditional techniques have difficulty in isolating a stationary object from a scene with a number of moving components, where the device obtaining the images contributes to the shift in the image or the video. In one aspect, additional inertial sensors coupled to the device may be used in detecting the motion associated with the device obtaining the images. One aspect of such a technique is described herein.

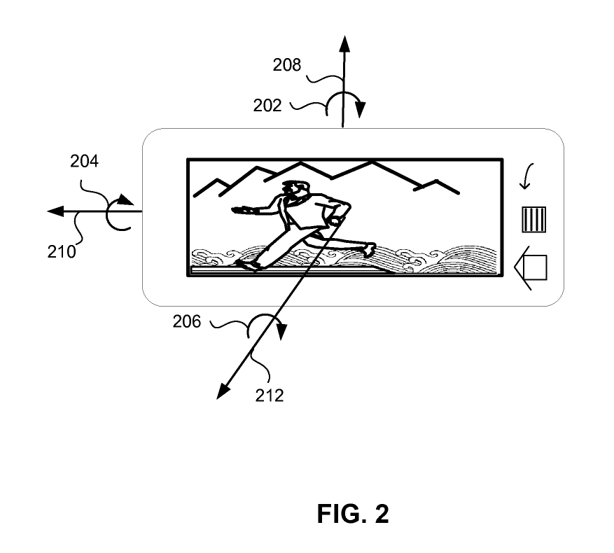

FIG. 2 is an exemplary mobile device equipped with inertial sensors. Most modern day mobile devices such as cell phones and smart phones are equipped with inertial sensors. Examples of inertial sensors include gyroscopes and accelerometers. Gyroscopes measure the angular velocity of the camera along three axes and accelerometers measure both the acceleration due to gravity and the dynamic acceleration of the camera along three axes. These sensors provide a good measure of the movement of the camera when held by a user. The movements include movements caused by panning as well as unintentional tremor. Referring to FIG. 2, the angular movement of the mobile device around the X, Y, and Z axes is represented by the arcs 202, 204 and 206 and may be measured by the gyroscope. The movement along the X, Y and Z axes is represented by the straight lines 208, 210 and 212.

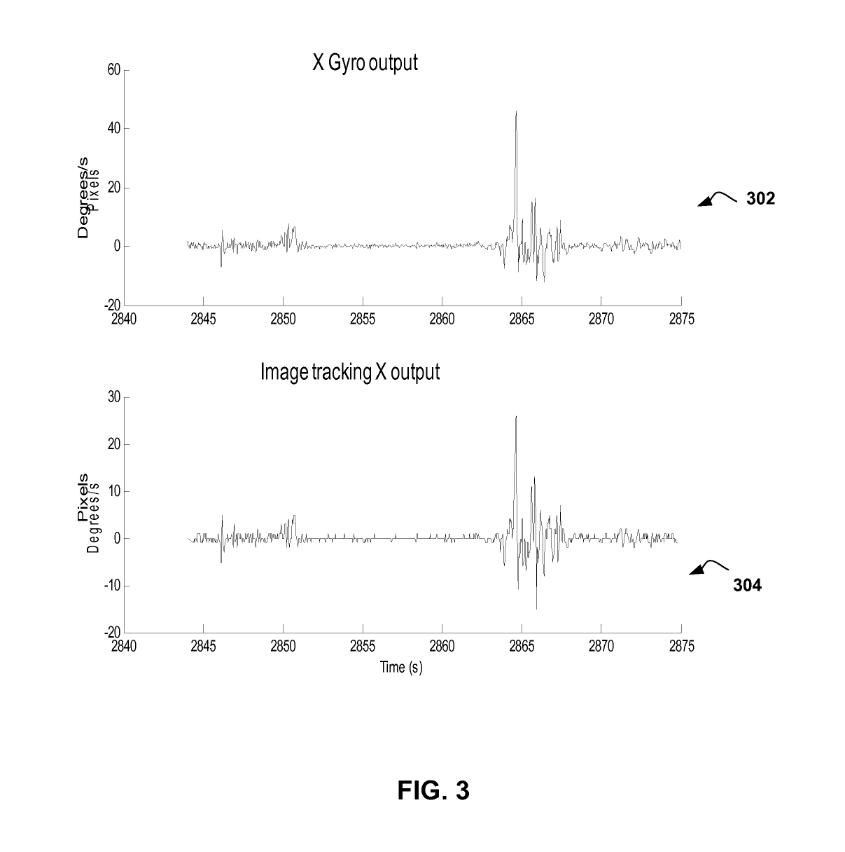

FIG. 3 is a graph comparing the image shift as calculated using a gyroscope output and image processing techniques. The image processing is performed on a sequence of images to determine the image shift associated with a unitary frame or image. The objects in the field of view of the device capturing the video for analysis are stationary. The only shift in the video is due to the motion associated with the device capturing the video. For instance, the motion could be a result of hand tremor from the person handling the device capturing the video. The upper graph in FIG. 3 (302) is a graph of the angular movement of the device around the X-axis as calculated using the gyroscope output from the gyroscope coupled to the device. The lower graph in FIG. 3 (304) is a graph of the angular movement of the device around the X-axis as calculated using image processing techniques on the sequence of images belonging to the video directly. As seen in FIG. 3, the graphs for the image shift as calculated using the gyroscope output (302) and the image processing techniques (304) are almost identical when all objects in the video are stationary. Therefore, the shift in the image as calculated using the gyroscope is almost identical to the shift in the image as calculated using image processing techniques when the objects in the field of view of the capturing device are all stationary. The same principal can be used on videos that include moving objects to identify stationary objects. Different portions or identified objects may be isolated and compared separately to the shift contributed by gyroscope to discount the shift from the gyroscope and identify the stationary objects in the video.

FIG. 4 is a logical block diagram 400 illustrating a non-limiting embodiment of the invention. The logical block diagram represents components of an aspect of the invention encapsulated by the device described in FIG. 7. Referring to FIG. 4, the camera 402 obtains the video image. In one aspect, the video image may be characterized as a continuous stream of digital images. The camera may have an image sensor, lens, storage memory and various other components for obtaining images. The image/video processor 404 may detect motion associated with the different portions of the image or video using image processing techniques in the related art.

One or more sensors 410 are used to detect motion associated with the motion of the camera coupled to the device. The one or more sensors 410 may be coupled to the device reflecting similar motion experienced by the camera. In one aspect, the sensors are inertial sensors that include accelerometers and gyroscopes. An accelerometer measures linear acceleration and a gyroscope measures angular rate, both without an external reference. Current inertial sensor technologies are focused on MEMS technology. MEMS technology enables quartz and silicon sensors to be mass produced at low cost using etching techniques with several sensors on a single silicon wafer. MEMS sensors are small, light and exhibit much greater shock tolerance than conventional mechanical designs. However, other technologies are also being researched for more sophisticated inertial sensors, such as Micro-Optical-Electro-Mechanical-Systems (MOEMS), that remedy some of the deficiencies related to capacitive pick-up in the MEMS devices. In addition to inertial sensors, other sensors that detect motion related to acceleration, or angular rate of a body with respect to features in the environment may also be used in quantifying the motion associated with the camera.

At logical block 406, the device performs a similarity analysis between the motion associated with the device using sensors 410 coupled to the device and the motion associated with the different portions of the image detected from the image processing 404 of the sequence of images from the video. At logical block 408, one or more stationary objects in the video are detected by identifying portions from the image that are most similar with the motion detected using the sensor.

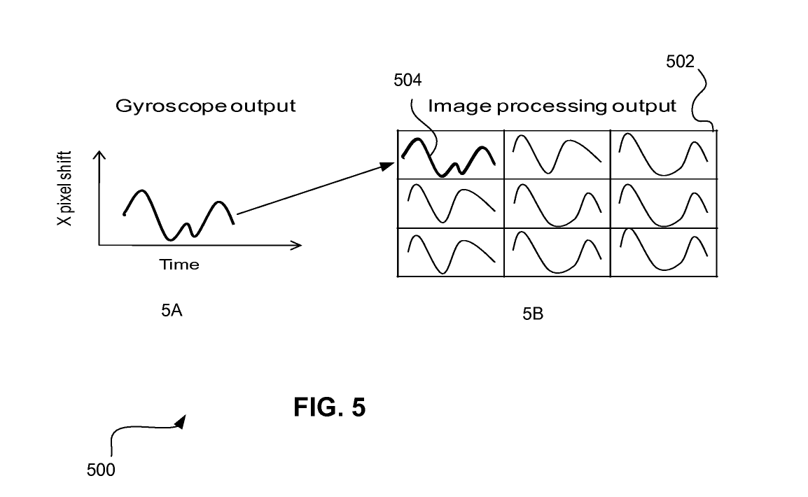

FIG. 5 is a non-limiting exemplary graphical representation of the motion associated with the device and the motion detected from the different portions of the image, respectively. The motion associated with the device is detected using a gyroscope. FIG. 5(A) represents the motion associated with the device and detected using a gyroscope. A gyroscope is used as an exemplary inertial sensor; however, one or more sensors may be used alone or in combination to detect the motion associated with the device. The expected image shift due to camera motion can also be calculated by integrating this gyroscope output and appropriately scaling the integrated output taking into account camera focal length, pixel pitch, etc.

FIG. 5(B) represents the shift associated with each of the multiple portions of the image from a sequence of images (502). The shift detected in the image using image processing techniques is a combination of the shift due to the motion from the device and the motion of the objects in the field of view of the camera. In one aspect, the motion associated with each of the multiple portions of the image is detected by analyzing a sequence of images. For example, from each image from a sequence of images, a portion from the image with the same relative location in the image is associated to form a sequence of portions from the images. Deviations in the sequence of portions from the images may be analyzed to determine the motion associated with that particular portion of the image.

As described herein, a sequence of images is a set of images obtained one after the other by the camera coupled to the device, in that order, but are not limited to images obtained by utilizing every consecutive image in a sequence of images. For example, in detecting the motion associated with a sequence of images, from a consecutive set of images containing the set of images 1, 2, 3, 4, 5, 6, 7, 8, and 9, the image processing technique may choose to obtain or utilize the sequential images 2, 6 and 9 in determining the motion associated with different portions of the image.

In one aspect, a portion of the image may be sub-frames, wherein the sub-frames are groupings of pixels that are related by their proximity to each other, as depicted in FIG. 5(B). In other aspects, portions of the image analyzed using image processing for detecting motion can be features like corners and edges. Techniques such as scale invariant features transform (SIFT) can be used to identify such features as portions of the images. Alternately, optical flow or other suitable image statistics can be measured in different parts of the image and tracked across frames.

Motion detected using the sensor (5(A)) and motion detected using image processing techniques for each portion of the image (502) are compared to find a portion from the image which is most similar (504) to the motion detected using the sensor (5(A)). The portion of the image with the most similarity to the motion detected using the sensor is identified as the stationary portion from the image. One or more portions may be identified as stationary portions in the image. The comparison between the motion from the sensor and the motion from the portions of the image for similarity may be a correlation, sum of absolute differences or any other suitable means.

Referring back to FIG. 1, in the scene the mountain range 106 is stationary. Traditional techniques may not identify the mountain range 106 as a stationary object in the video frame due to the motion contributed by the capturing device. However, even though the image obtained would have motion associated with the mountain ranges 106, the above described technique would identify the mountain ranges as stationary objects.

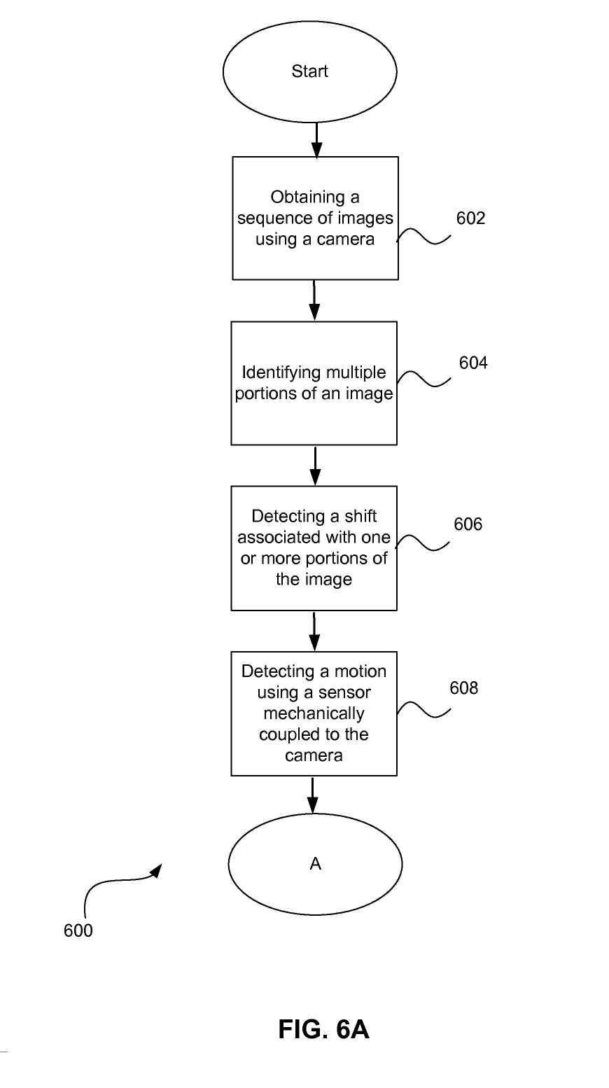

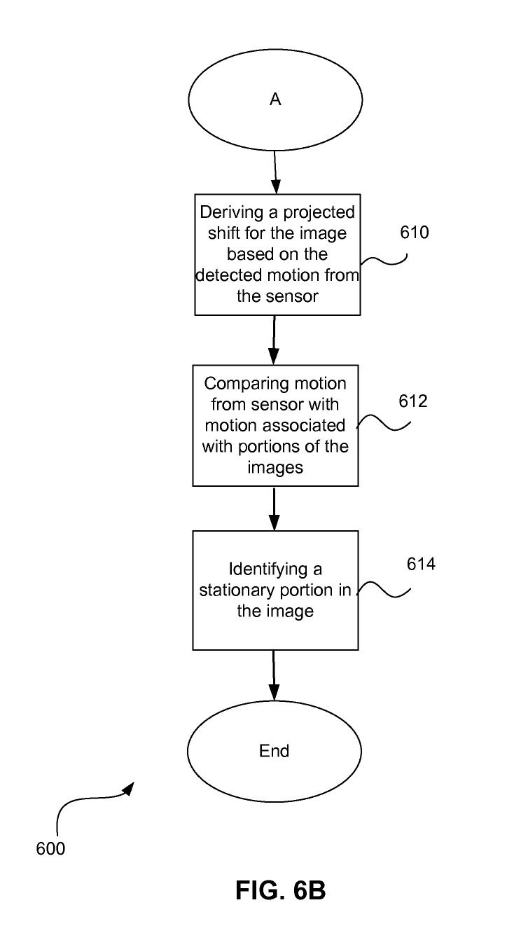

FIG. 6 is a simplified flow diagram, illustrating a method 600 for identifying a stationary portion of an image. The method 600 is performed by processing logic that comprises hardware (circuitry, dedicated logic, etc.), software (such as is run on a general purpose computing system or a dedicated machine), firmware (embedded software), or any combination thereof. In one embodiment, the method 600 is performed by device 700 of FIG. 7.

Referring to FIG. 6, at block 602, the camera mechanically coupled to the device obtains a sequence of images. In one aspect, the video image may be characterized as a continuous stream of digital images. The camera may have an image sensor, lens, storage memory and various other components for obtaining an image.

At block 604, the device identifies multiple portions from an image from the sequence of images. Multiple portions from an image may be identified using a number of suitable methods. In one aspect, the image is obtained in a number of portions. In another aspect, the image is obtained and then separate portions of the image are identified. A portion of the image may be a sub-frame, wherein the sub-frames are groupings of pixels that are related by their proximity to each other, as depicted in FIG. 5(B). In other aspects, portions of the image analyzed using image processing for detecting motion can be features like corners and edges. Techniques such as scale invariant features transform (SIFT) can be used to identify such features as portions of the images. Alternately, optical flow or other suitable image statistics can be measured in different parts of the image and tracked across frames.

At block 606, the device detects a shift associated with each of the multiple portions of a sequence of images or a video. The shift detected in the image using image processing techniques is a combination of the shift due to the motion from the device capturing the video and the motion of the objects in the field of view of the camera. In one aspect, the shift associated with each of the multiple portions of the image is detected by analyzing a sequence of images. For example, from each image from a sequence of images, a portion from the image with the same relative location in the image is associated to form a sequence of portions from the images. Deviations in the sequence of portions from the images may be analyzed to determine the shift associated with that particular portion of the image. As described herein, a sequence of images is a set of images obtained one after the other, in that order, but are not limited to images obtained by utilizing every consecutive image in a sequence of images.

At block 608, the device detects motion using one or more sensors mechanically coupled to the camera. In one aspect the sensors are inertial sensors that include accelerometers and gyroscopes. An accelerometer measures linear acceleration and a gyroscope measures angular rate, both without an external reference. Current inertial sensor technologies are focused on MEMS technology. However, other technologies are also being researched for more sophisticated inertial sensors, such as Micro-Optical-Electro-Mechanical-Systems (MOEMS), that remedy some of the deficiencies related to capacitive pick-up in the MEMS devices. In addition to inertial sensors, other sensors that detect motion related to acceleration, or angular rate of a body with respect to features in the environment may also be used in quantifying the motion associated with the camera.

At block 610, the device derives a projected shift for the image based on the detected motion of the camera using the sensor. The projected image shift due to the camera motion (as measured by the inertial sensors) is calculated by appropriately scaling the camera movement taking into account the camera's focal length, pixel pitch, etc.

At block 612, the device compares the projected shift detected using the sensor with the shift associated with each portion of the image. Shift detected using the sensor and shift detected using image processing techniques for each portion of the image are compared to find a shift associated with a portion from the image which is most similar with the shift detected using the sensor. At block 614, the device identifies a portion from the image which is most similar with the motion detected using the sensor, as a stationary portion of the image. One or more portions may be identified as stationary portions in the image. The comparison between the motion from the sensor and the motion from the portions of the image for similarity may be a correlation, sum of squares or any other suitable means.

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 600.

A computer system as illustrated in FIG. 7 may be incorporated as part of the previously described computerized device. For example, computer system 700 can represent some of the components of a mobile device. A mobile device may be any computing device with an input sensory unit like a camera and a display unit. Examples of a mobile device include but are not limited to video game consoles, tablets, smart phones and mobile devices. FIG. 7 provides a schematic illustration of one embodiment of a computer system 700 that can perform the methods provided by various other embodiments, as described herein, and/or can function as the host computer system, a remote kiosk/terminal, a point-of-sale device, a mobile device, a set-top box and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, sensors (including inertial sensors), a mouse, a keyboard and/or the like; and one or more output devices 720, which can include without limitation a display unit, a printer and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 730, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for identifying a stationary portion, the method comprising:
obtaining a sequence of images using a camera;
detecting a shift associated with at least one of a plurality of portions of an image;
detecting a motion using a sensor mechanically coupled to the camera;
deriving a projected shift for the image based on the detected motion of the camera using the sensor;
comparing the derived projected shift with the shift associated with the at least one of the plurality of portions of the image; and
identifying the at least one of the plurality of portions of the image as the stationary portion of the image by identifying that the shift associated with the at least one of the plurality of portions is most similar to the derived projected shift.

2. The method of claim 1, wherein detecting the shift associated with the at least one of the plurality of portions of the image comprises:
associating, from the image, the at least one of the plurality of portions of the image with a same relative location from the sequence of images to generate a sequence of portions from the sequence of images; and
determining the shift associated with the at least one of the plurality of portions of the image using deviations in a plurality of pixels in the sequence of portions from the sequence of images.

3. The method of claim 1, wherein detecting the shift associated with the at least one of the plurality of portions of the image comprises analyzing a plurality of similarly situated corresponding portions throughout the sequence of images.

4. The method of claim 1, wherein the projected shift for the image from the sequence of images is derived using a scaled value of the motion.

5. The method of claim 1, wherein the sensor is an inertial sensor.

6. The method of claim 1, wherein the sensor is one or more from a group comprising of a gyroscope, an accelerometer and a magnetometer.

7. The method of claim 1, wherein the shift in the image is from movement of the camera obtaining the image.

8. The method of claim 1, wherein the shift in the image is from movement by an object in a field of view of the camera.

9. The method of claim 1, wherein the shift associated with the at least one of the plurality of portions of the image is correlated with the motion detected using the sensor.

10. The method of claim 1, wherein the camera is non-stationary.

11. The method of claim 1, wherein the similarity in the shift of the stationary portion of the image and the projected shift associated with the motion detected using the sensor is identified by deriving a correlation between the shift of the plurality of portions of the image and the projected shift associated with the motion detected using the sensor.

12. The method of claim 1, wherein identifying the stationary portion of the image is used for surveillance, moving object detection and intruder detection in videos.

13. The method of claim 1, wherein identifying the stationary portion of the image is used for video and image stabilization.

14. The method of claim 1, wherein identifying multiple portions of the image comprises identifying multiple features from the image.

15. The method of claim 1, wherein the sequence of images belongs to a video stream.

16. A device, comprising:
a processor;
a camera for obtaining images;
a sensor for detecting a motion associated with the device; and
a non-transitory computer-readable storage medium coupled to the processor, wherein the non-transitory computer-readable storage medium comprises code executable by the processor for implementing a method comprising:
obtaining a sequence of images using the camera;
detecting a shift associated with at least one of a plurality of portions of an image;
detecting the motion using the sensor mechanically coupled to the camera;
deriving a projected shift for the image based on the detected motion of the camera using the sensor;
comparing the derived projected shift with the shift associated with the at least one of the plurality of portions of the image; and
identifying the at least one of the plurality of portions of the image as a stationary portion of the image by identifying that the shift associated with the at least one of the plurality of portions is most similar to the derived projected shift.

17. The device of claim 16, wherein detecting the shift associated with the at least one of the plurality of portions of the image comprises:
associating, from the image, the at least one of the plurality of portions of the image with a same relative location from the sequence of images to generate a sequence of portions from the sequence of images; and
determining the shift associated with the at least one of the plurality of portions of the image using deviations in a plurality of pixels in the sequence of portions from the sequence of images.

18. The device of claim 16, wherein detecting the shift associated with the at least one of the plurality of portions of the image comprises analyzing a plurality of similarly situated corresponding portions throughout the sequence of images.

19. The device of claim 16, wherein the projected shift for the image from the sequence of images is derived using a scaled value of the motion.

20. The device of claim 16, wherein the sensor is an inertial sensor.

21. The device of claim 16, wherein the sensor is one or more from a group comprising of a gyroscope, an accelerometer and a magnetometer.

22. The device of claim 16, wherein the shift in the image is from movement of the camera obtaining the image.

23. The device of claim 16, wherein the shift in the image is from movement by an object in a field of view of the camera.

24. The device of claim 16, wherein the shift associated with the at least one of the plurality of portions of the image is correlated with the motion detected using the sensor.

25. The device of claim 16, wherein the camera is non-stationary.

26. The device of claim 16, wherein the similarity in the shift of the stationary portion of the image and the projected shift associated with the motion detected using the sensor is identified by deriving a correlation between the shift of the plurality of portions of the image and the projected shift associated with the motion detected using the sensor.

27. The device of claim 16, wherein identifying the stationary portion of the image is used for surveillance, moving object detection and intruder detection in videos.

28. The device of claim 16, wherein identifying the stationary portion of the image is used for video and image stabilization.

29. The device of claim 16, wherein identifying multiple portions of the image comprises identifying multiple features from the image.

30. The device of claim 16, wherein the sequence of images belongs to a video stream.

31. A non-transitory computer-readable storage medium coupled to a processor, wherein the non-transitory computer-readable storage medium comprises a computer program executable by the processor for implementing a method comprising:
obtaining a sequence of images using a camera;
detecting a shift associated with at least one of a plurality of portions of an image;
detecting a motion using a sensor mechanically coupled to the camera;
deriving a projected shift for the image based on the detected motion of the camera using the sensor;
comparing the derived projected shift with the shift associated with the at least one of the plurality of portions of the image; and
identifying the at least one of the plurality of portions of the image as a stationary portion of the image by identifying that the shift associated with the at least one of the plurality of portions is most similar to the derived projected shift.

32. The non-transitory computer-readable storage medium of claim 31, wherein detecting the shift associated with the at least one of the plurality of portions of the image comprises:
associating, from the image, the at least one of the plurality of portions of the image with a same relative location from the sequence of images to generate a sequence of portions from the sequence of images; and
determining the shift associated with the at least one of the plurality of portions of the image using deviations in a plurality of pixels in the sequence of portions from the sequence of images.

33. The non-transitory computer-readable storage medium of claim 31, wherein detecting the shift associated with the at least one of the plurality of portions of the image comprises analyzing a plurality of similarly situated corresponding portions throughout the sequence of images.

34. The non-transitory computer-readable storage medium of claim 31, wherein the projected shift for the image from the sequence of images is derived using a scaled value of the motion.

35. The non-transitory computer-readable storage medium of claim 31, wherein the sensor is an inertial sensor.

36. The non-transitory computer-readable storage medium of claim 31, wherein the sensor is one or more from a group comprising of a gyroscope, an accelerometer and a magnetometer.

37. The non-transitory computer-readable storage medium of claim 31, wherein the shift in the image is from movement of the camera obtaining the image.

38. The non-transitory computer-readable storage medium of claim 31, wherein the shift in the image is from movement by an object in a field of view of the camera.

39. The non-transitory computer-readable storage medium of claim 31, wherein the shift associated with the at least one of the plurality of portions of the image is correlated with the motion detected using the sensor.

40. The non-transitory computer-readable storage medium of claim 31, wherein the camera is non-stationary.

41. The non-transitory computer-readable storage medium of claim 31, wherein the similarity in the shift of the stationary portion of the image and the projected shift associated with the motion detected using the sensor is identified by deriving a correlation between the shift of the plurality of portions of the image and the projected shift associated with the motion detected using the sensor.

42. The non-transitory computer-readable storage medium of claim 31, wherein identifying the stationary portion of the image is used for surveillance, moving object detection and intruder detection in videos.

43. The non-transitory computer-readable storage medium of claim 31, wherein identifying the stationary portion of the image is used for video and image stabilization.

44. The non-transitory computer-readable storage medium of claim 31, wherein identifying multiple portions of the image comprises identifying multiple features from the image.

45. The non-transitory computer-readable storage medium of claim 31, wherein the sequence of images belongs to a video stream.

46. An apparatus for identifying a stationary portion, comprising:
means for obtaining a sequence of images using a camera;
means for detecting a shift associated with at least one of a plurality of portions of an image;
means for detecting a motion using a sensor mechanically coupled to the camera;
means for deriving a projected shift for the image based on the detected motion of the camera using the sensor;
means for comparing the derived projected shift with the shift associated with the at least one of the plurality of portions of the image; and
means for identifying the at least one of the plurality of portions of the image as the stationary portion of the image by identifying that the shift associated with the at least one of the plurality of portions is most similar to the derived projected shift.

47. The apparatus of claim 46, wherein the sensor is an inertial sensor.

48. The apparatus of claim 46, wherein identifying multiple portions of the image comprises identifying multiple features from the image.

49. The apparatus of claim 46, wherein the sequence of images belongs to a video stream.
